(19) United States
(12) Patent Application Publication
(10) Pub. No.: US 2003/0208494 A1
(43) Pub. Date: Nov. 6, 2003

(54) System and method for multidimensional valuation of consumer technology customers

(76) Inventor: Pierre Denis Francois Olivier, Berkeley, CA (US)

Correspondence Address: HEWLETT-PACKARD COMPANY, Intellectual Property Administration, P.O. Box 272400, Fort Collins, CO, 80527-2400, US

(21) Appl. No.: 10/122,987

(22) Filed: Apr. 15, 2002

(51) Int. Cl. G06F 7/00

(52) U.S. Cl. 707/100

(57) ABSTRACT

A system and method for a multi-dimensional analysis of consumer technology customers. One embodiment provides a method for multidimensional valuation of consumer technology customers. The method includes retrieving customer data relating to customers who purchased at least one product from a group of consumer technology products offered by a company, calculating a base value for the customers, calculating a service value for the customers, calculating a potential value for the customers, calculating a referral value for the customers, combining the base, service, potential, and referral values to determine the multidimensional valuation of the consumer technology customers.

### BACKGROUND

1. Field of the Invention

The present invention relates in general to the consumer technology industry. More particularly, the present invention relates to evaluating customers of the consumer technology industry.

2. Description of the Background Art

In the consumer technology industry, information on customers is typically only used, if at all, in a limited, simple and non-automated way. Some companies do not gather such information at all or may only store the information for warranty purposes. Other companies may simply mail all customers on their lists periodically. Other companies intend to use the customer information but lack tools for doing analyses of customer information.

FIG. 1 is a flow chart depicting a conventional marketing information process 100 for evaluating customer data for consumer technology products. The process 100 has two different possible types of results. The first type of result for process 100 as depicted includes five steps.

In a first step 102, the customer buys a consumer technology product. Such purchases may be made at a retail outlet, at a manufacturer outlet, by telephone sales, via a retail or manufacturer catalog, or online, either from an online retailer or directly from the manufacturer. For example, a customer may buy a personal computer from a large warehouse type retail outlet geared toward selling computer equipment.

In a second step 104, the customer provides various information in order to obtain the warranty for the consumer technology product. The customer may provide such information through a retailer or directly to the manufacturer. Such information may be provided by a mailed card or letter, through an email, via a Website or over the telephone to a customer service representative. The customer may purchase additional service contracts and provide additional information for such contracts. For example, after buying a personal computer, a customer may fill out various details, such as name, address, phone number, place and date of purchase and price paid, on the warranty card provided with the personal computer and mail the card to the manufacturer.

In a third step 106, the customer information provided for the warranty is entered into a database. Typically, the database is an electronic database maintained using standard or proprietary database software.

In a fourth step 108, the customer information in the database is analyzed by a marketing person by hand or via simple software. The simple software may consist of spreadsheet programs or other analytical software. For example, when involved in a new product launch, a marketing person may look at the customer information, enter the data into spreadsheets and try to discern useful patterns using spreadsheet tools.

In a fifth step 110, the marketing person who analyzes the customer information by hand or via simple software devises a marketing plan based on the customer information and the resulting analysis. For example, the marketing person may look at what product attributes customers in a certain geographic location typically prefer and market products with similar product attributes to those locations.

The second type of result for process 100 is similar to the first type of result with both types of results having the same initial three steps, step 102, step 104 and step 106. The difference is that the second type of result as depicted includes four steps instead of five, with the last step 112 substituting for the fourth step 108 and the fifth step 110 in the first type of result. In the last step 112, customer information in the database is used to contact customers about new products and accessories. The customer may be contacted for new products and accessories when the new products or accessories become available, when an aggressive marketing and sales drive is desired for corporate reasons, when the market, product or accessory matures, or when new products or accessories suffer a drop-off in sales. For example, a company may use customers' names and addresses contained in the customer database to mail promotional material about a new printer to customers who own the company's computers.

### SUMMARY

The present invention relates to a system and method for a multi-dimensional analysis of consumer technology customers. One embodiment provides a method for multidimensional valuation of consumer technology customers. The method includes retrieving customer data relating to customers who purchased at least one product from a group of consumer technology products offered by a company, calculating a base value for the customers, calculating a service value for the customers, calculating a potential value for the customers, calculating a referral value for the customers, and combining the base, service, potential, and referral values to determine the multidimensional valuation of the consumer technology customers.

### BRIEF DESCRIPTION OF THE DRAWINGS

Non-limiting and non-exhaustive embodiments of the present invention are described in the Figures, in which:

FIG. 1 is a flow chart depicting a conventional marketing information process for evaluating customer data for consumer technology products.

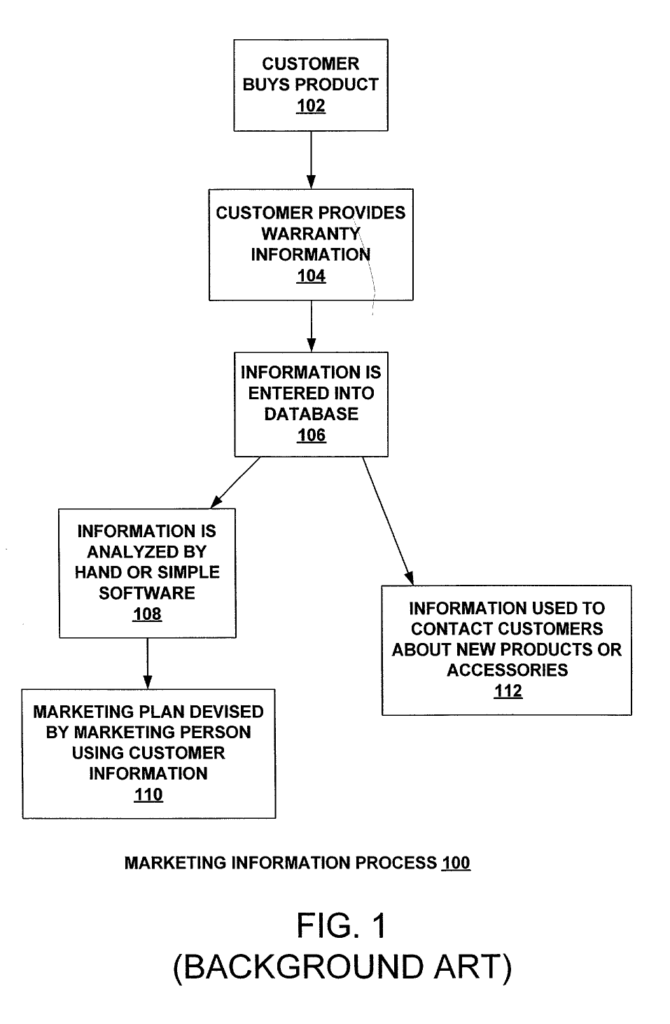

FIG. 2 is a flow chart depicting a multi-dimensional valuation method in accordance with an embodiment of the invention.

FIG. 3 is a diagram depicting a system in accordance with an embodiment of the invention.

FIG. 4 is a diagram illustrating calculation of a total value for consumer technology customers in accordance with an embodiment of the invention.

FIG. 5 is a diagram illustrating calculation of a base value for consumer technology customers in accordance with an embodiment of the invention.

FIG. 6 is a diagram illustrating calculation of a service value for consumer technology customers in accordance with an embodiment of the invention.

FIG. 7 is a diagram illustrating calculation of a potential value for consumer technology customers in accordance with an embodiment of the invention.

FIG. 8 is a diagram illustrating calculation of a referral value for consumer technology customers in accordance with an embodiment of the invention.

FIG. 9 is a diagram illustrating the grouping of consumer technology customers in accordance with an embodiment of the invention.

FIG. 10 is a diagram illustrating categorizing groups of consumer technology customers in accordance with an embodiment of the invention.

### DETAILED DESCRIPTION

Deficiencies in Prior Systems and Methods

One prior way companies use to evaluate customer information is based on a single or a limited numbers of variables, often evaluated separately with each variable looked at one at a time. In other words, any multidimensional analyses conducted is typically only conducted as a sequential set of single dimensional analyses. For example, a company may look at what product attributes customers in a certain geographic location typically prefer and market products with similar product attributes to those locations. Or a company may look only for gender differences in purchasing patterns and then take the next step of analyzing those gender differences in terms of different age brackets. Once the company has broken down the customers into social categories based on the customer information, the company may gear future marketing to the sub-categories that have purchased the most of their products.

Another prior way companies use customer information is to use only the contact information in the database. This method has shortcomings as no substantial valuation is done of customer behavior or customer value using available data. For example, companies may use the contact information, such as customer names and addresses, to mail letters, flyers, advertising or other promotional material to customers when new products or accessories are launched on the market.

In other prior ways to evaluate customers using customer data, companies typically only look toward specific marketing needs rather than tying the customer valuation specifically to major corporate objectives. The drawback to this method is that customers are not systematically evaluated on multiple dimensions as to their actual and potential contribution to major corporate objectives. Marketing plans are drawn up with the basic information on the customer merely to sell more products to all customers without using the customer data to evaluate more efficient ways of selling to customers. For example, even though most major corporate objectives includes profitability or consumer loyalty as opposed to mere revenue growth, current marketing plan methods based on customer data typically do not try to determine if the customer might be a influencer or “smart friend” whose opinion on products others seek out and respect or if the customer might have substantial future cross-selling value based on purchasing characteristics. Thus, the current methods may have the drawback of using customer data in marketing plans to focus unduly on revenue growth instead of profitability or consumer loyalty.

Marketing analysis of customer information is currently usually conducted in an ad hoc manner and on an as-needed basis by marketing personnel using simple tools. The drawback to this method is that the analysis is simplistic and requires substantial human effort and expertise. Moreover, because of the ad hoc nature, the analysis does not usually get improved and refined over time. For example, when involved in a new product launch, marketing persons may look at past customer data, enter the data into spreadsheets and try to discern useful patterns using spreadsheet tools. Not only is this method unsophisticated, simplistic and unsystematic, typically very few aspects of the marketing analysis methods for evaluating customer information are automated. Consequently, existing methods are cumbersome, time consuming, inefficient and unsystematic.

Under prior methods, later contact with customers is done on a basic level without substantial personalization and customization because customer databases are not currently set up or analyzed to provide more sophisticated information on the customer. For example, prior simple analytical tools do not allow for automatic distinguishing of influencers or “smart friends” who might benefit from receiving substantial correspondence as to product attributes and advantages.

Hence, customer data has been collected and stored for consumer technology products but is not used fully or effectively. A more useful and efficient way of processing and analyzing the customer data and evaluating each customer is needed. Embodiments of the current invention may use an automated multi-dimensional analysis of customer information to determine various customer values. A multi-dimensional analysis will be more sophisticated and comprehensive, provide a better valuation of the customer, and allow for more accurate prediction of customer behavior. Extensive automation of the customer valuation and valuation process will be more efficient and effective than existing methods. In addition, embodiments of the invention may use algorithms to measure customer value more closely against critical corporate goals so that consumer technology companies can more effectively respond to customer needs in ways conducive to corporate success. Further, embodiments of the invention may allow automatic and systematic generation of marketing action plans, marketing materials and electronic mail messages to customers and marketing personnel. This will allow for more systematic, sophisticated, complex, detailed, subtle, personalized and customized marketing plans, materials, and electronic mail messages to customers.

As used herein, consumer technology products include all types of technology products used by individual and business consumers, including personal computers, printers, servers, laptops, cell phones, personal digital assistants, monitors, telephones, audio equipment, cameras, facsimile machines, televisions, radios, DVD players, video players, scanners, electronic calendaring devices, calculators, appliances and copiers.

Description of Specific Embodiments of the Invention

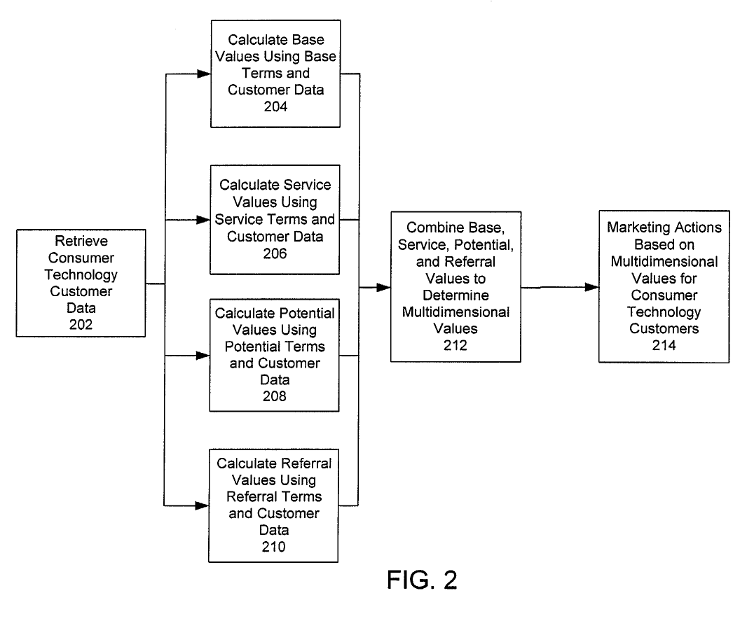

FIG. 2 is a flow chart depicting a multi-dimensional valuation method 200 in accordance with an embodiment of the invention. The method 200 as depicted includes seven steps (202, 204, 206, 208, 210, 212, and 214).

In a first step 202, data is retrieved relating to consumer technology customers. Such data may be stored in a customer database and obtained by various techniques. One technique obtains data when a customer buys a consumer technology product. Such purchases may be made at a retail outlet, at a manufacturer outlet, by telephone sales, via a retail or manufacturer catalog, or online, either from an online retailer or directly from the manufacturer. For example, a customer may buy a personal computer from a large warehouse type retail outlet geared toward selling computer equipment. In another technique, data may be obtained when a consumer technology customer provides various information in order to obtain the warranty for the consumer technology product. The customer may provide such information through a retailer or directly to the manufacturer. Such information may be provided by a mailed card or letter, through an email, via a Website or over the telephone to a customer service representative. The customer may purchase additional service contracts and provide additional information for such contracts. For example, after buying a personal computer, a customer may fill out various details, such as name, address, phone number, place and date of purchase and price paid, on the warranty card provided with the personal computer and mail the card to the manufacturer.

In the second through fifth steps (204, 206, 208, and 210), multiple customer valuation dimensions are calculated. These steps may, for example, be done in parallel as illustrated in FIG. 2. The calculations use the customer data from the first step 202.

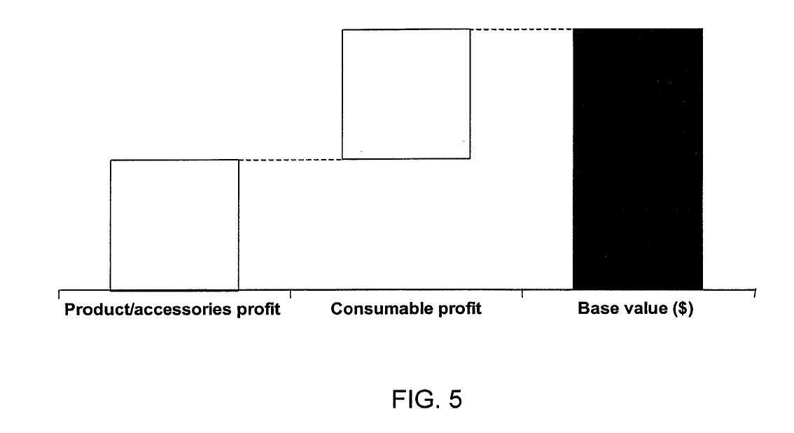

In the second step 204, base values are calculated using base terms and the customer data. The calculation of base values is described further below in relation to FIG. 5.

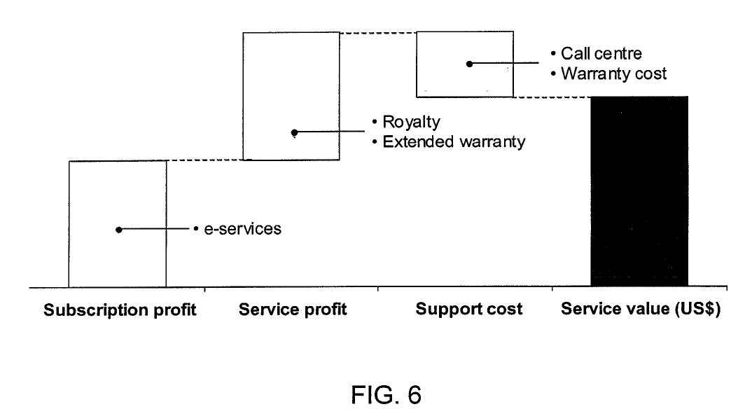

In the third step 206, service values are calculated using service terms and the customer data. The calculation of service values is described further below in relation to FIG. 6.

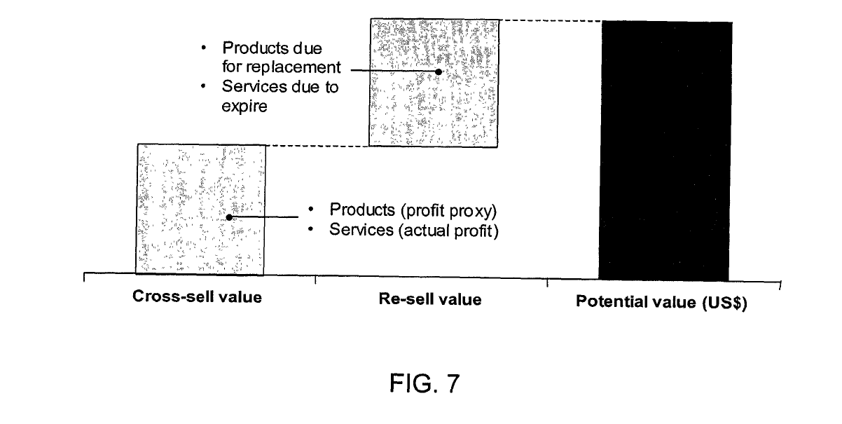

In the fourth step 208, potential values are calculated using potential terms and the customer data. The calculation of potential values is described further below in relation to FIG. 7.

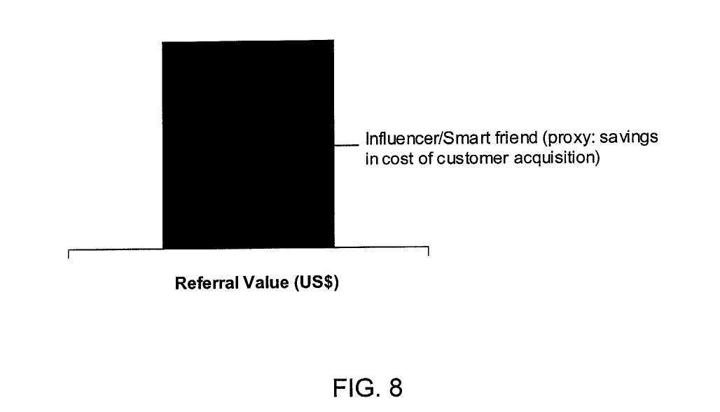

In the fifth step 210, referral values are calculated using referral terms and the customer data. In this step, customers are identified who are expected to be influencers or “smart friends,” whose opinion on products others seek out and respect, and a higher referral value is attributed to those customers as they can bring substantial cost savings in marketing since these customers do some of the marketing and selling for the consumer technology company. The calculation of referral values is described further below in relation to FIG. 8.

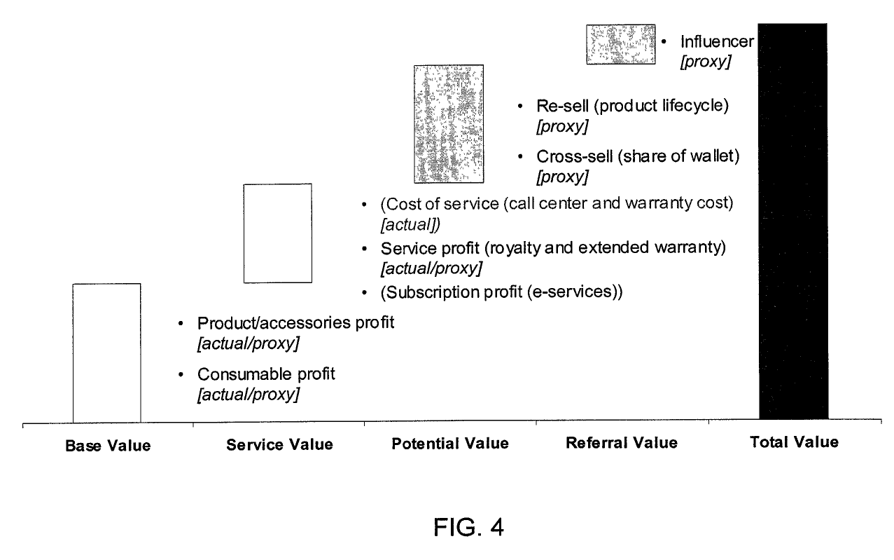

In the sixth step 212, the calculated base, service, potential and referral values are combined to determine total calculated (multidimensional) values for the consumer technology customers. The combination of the various dimensional values into a total value for a customer is described further below in relation to FIG. 4.

In the seventh step 214, the total values of the consumer technology customers from sixth step 212 are used as a basis for marketing actions. In one embodiment, this involves grouping the consumer technology customers into different groupings based on their total values. For example, customers with a very high total value may be selected later for special discounts designed to keep loyal customers or for special bonus items such as corporate T-shirts.

In another embodiment, marketing plans may be generated based on the total values. For example, a plan to increase advertising in regions with few high value customers may be generated since those regions need better customer development.

In another embodiment, electronic mail messages are automatically generated and sent to customers at appropriate times with messages geared towards that customer. High value customers may be treated specially as they have and are likely to continue to bring disproportionate value to the consumer technology company. For example, electronic mail messages may be automatically generated and sent wishing high value customers happy birthday on their birthdays.

In another embodiment, targeted advertising and promotions are generated. For example, special coupons may be generated for high value customers to use for birthdays and special occasions.

In another embodiment, influencers or “smart friends” are identified and targeted. For example, special programs such as training classes may be created for high value influencer or “smart friends” to attend.

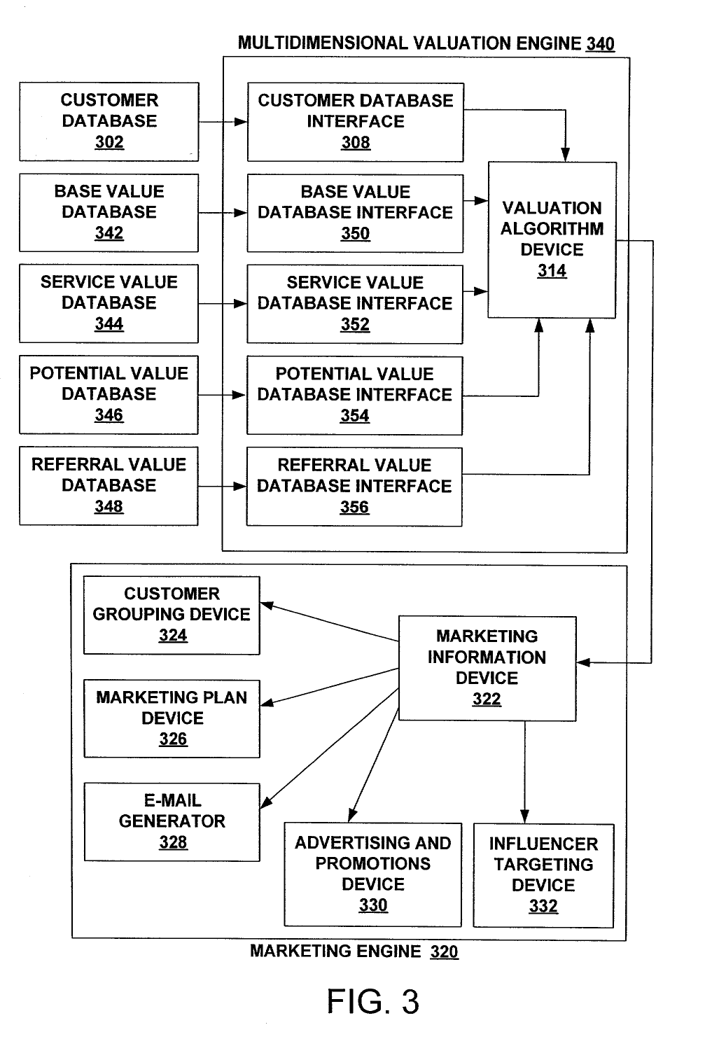

FIG. 3 is a diagram depicting a system in accordance with an embodiment of the invention. The system includes a multi-dimensional valuation engine 340 coupled with a marketing engine 320.

The multi-dimension valuation engine 340 includes a valuation algorithm device 314. The valuation algorithm device 314 may automatically evaluate the customer data in customer database 302 multi-dimensionally against a variety of factors as determined from information contained in various databases in order to determine total calculated values for the consumer technology customers.

The valuation algorithm device 314 is connected to the customer database 302 through the customer database interface 308, to the base value database 342 through the base value database interface 350, to the service value database 344 through the service value database interface 352, to the potential value database 346 through the potential value database interface 354, and to the referral value database 348 through the referral value database interface 356.

The customer information contained in the customer database 302 is data relating to consumer technology customers. Such data may be obtained by various techniques. One technique obtains data when a customer buys a consumer technology product. Such purchases may be made at a retail outlet, at a manufacturer outlet, by telephone sales, via a retail or manufacturer catalog, or online, either from an online retailer or directly from the manufacturer. For example, a customer may buy a personal computer from a large warehouse type retail outlet geared toward selling computer equipment. In another technique, data may be obtained when a consumer technology customer provides various information in order to obtain the warranty for the consumer technology product. The customer may provide such information through a retailer or directly to the manufacturer. Such information may be provided by a mailed card or letter, through an email, via a Website or over the telephone to a customer service representative. The customer may purchase additional service contracts and provide additional information for such contracts. For example, after buying a personal computer, a customer may fill out various details, such as name, address, phone number, place and date of purchase and price paid, on the warranty card provided with the personal computer and mail the card to the manufacturer.

The base values in the base value database 342 may include the calculated base product or accessory value of the product or accessory bought by the customer, determined using base terms. The calculation of the base value is described in further detail below in relation with FIG. 5.

The service values in the service value database 344 may be the calculated value of related services purchased or to be purchased by the customer, determined using service terms. The calculation of the service value is described in further detail below in relation with FIG. 6.

The potential values in the potential value database 346 may be the calculated potential value of the customer to make later purchases of related, subsequent or similar products, determined using potential terms. The calculation of the potential value is described in further detail below in relation with FIG. 7.

The referral values in the referral value database 348 may be the calculated value of any referrals the customer may make, determined using referral terms. The calculation of the referral value is described in further detail below in relation with FIG. 8.

In order to determine final or composite values for each customer, the valuation algorithm device 314 may automatically evaluate the customer data in customer database 302 multi-dimensionally against a variety of factors and incorporate calculated base values as determined from information contained in the base value database 342, calculated service values as determined from information contained in the service value database 344, calculated potential values as determined from information contained in the potential value database 346, and calculated referral values as determined from information contained in the referral value database 348.

The valuation performed by the valuation algorithm device 314 may incorporate many different aspects. For example, in one embodiment, the device 314 may incorporate aspects and employ algorithms designed to evaluate the customer information based on alignment with major corporate objectives, such as revenue growth, profit or consumer loyalty. Algorithms may be incorporated that calculate such values based on perceived values related to corporate objectives and that incorporate notions of the base product value of the product bought by the customer, the value of related services purchased or to be purchased by the customer, the potential value of the customer to make later purchases of related, subsequent or similar products, and the value of any referrals the customer may make.

In another embodiment, the device 314 may include the ability to modify the algorithms as valuation terms or factors change. For example, shifts in emphasis on different corporate objectives may change valuation parameters and require the valuation algorithms to be adjusted automatically or manually. If valuation terms do change, the device 314 may be able to recalibrate itself to produce new total or composite values reflecting the new circumstances.

In another embodiment, only major contributing factors to the perceived value of the customer may be incorporated into the algorithms of device 314. For example, in looking at the potential value of the customer to make later purchases, only the value of the ability to resell subsequent products or cross-sell related products to the customer are considered while demographic variables may be downplayed or ignored.

In another embodiment, geographical and other variable factors may be incorporated into the algorithms of device 314 to create a more complex valuation methodology within device 314. These factors vary the multi-dimensional analysis. For example, consumer ownership patterns may vary in different geographical regions and may affect the valuation of the ability to resell later as new products come out.

The multi-dimensional valuation engine 340 may provide a total or a composite value that incorporates base, service, potential, and referral values for each customer as well as customer information, which may all be sent to the marketing information device 322 within the marketing engine 320. The marketing information device 322 may evaluate the customer value and customer information and determine what marketing processes may be facilitated by such information.

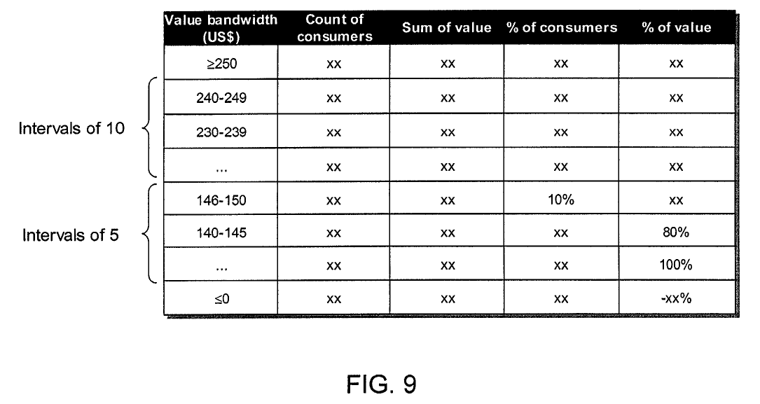

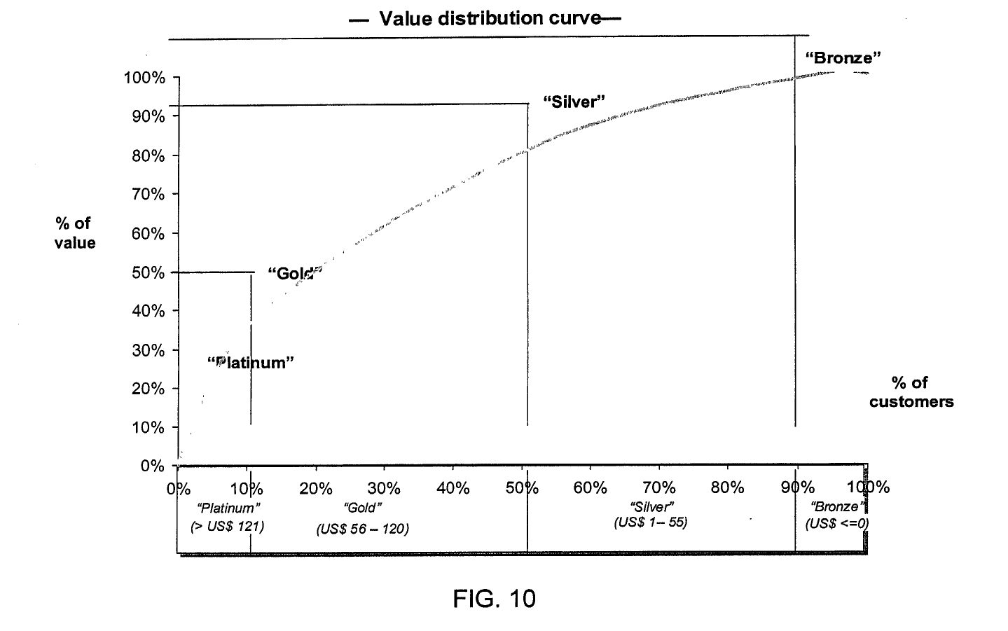

If the marketing information device 322 determines that grouping may be facilitated, customer information and valuation may be sent to the customer grouping device 324, where customers may be grouped into different groupings based on their total value. Such groupings may be helpful in designing or implementing later marketing programs. For example, customers with a very high total value may be selected later for special discounts designed to keep loyal customers or for special bonus items such as corporate T-shirts. Grouping of consumer technology customers in accordance with one embodiment is described further below in relation to FIGS. 9 and 10.

If the marketing information device 322 determines that automatic marketing plans may be generated, customer information and valuation may be sent to the marketing plan device 326, where basic marketing plans may be generated. For example, a plan to increase advertising in regions with few high value customers may be generated since those regions need better customer development.

If the marketing information device 322 determines that electronic mail messages may be generated and sent automatically, customer information and valuation may be sent to the email generator 328, where electronic mail messages may be automatically generated and sent to customers at appropriate times with messages geared towards that customer. High value customers may be treated specially as they have and are likely to continue to bring disproportionate value to the consumer technology company. For example, electronic mail messages may be automatically generated and sent wishing high value customers happy birthday on their birthdays.

If the marketing information device 322 determines that targeted advertising and promotions are warranted, customer information and valuation may be sent to the advertising and promotions device 330, where targeted advertising and promotions may be generated automatically. For example, special coupons may be generated for high value customers to use for birthdays and special occasions.

If the marketing information device 322 determines that influencers may be appropriately targeted, customer information and valuation may be sent to the influencer targeting device 332, where influencers or “smart friends” may be identified and targeted. For example, special programs such as training classes may be created for high value influencer or “smart friends” to attend.

FIG. 4 is a diagram illustrating calculation of a total value for consumer technology customers in accordance with an embodiment of the invention. The total value for a consumer technology customer may incorporate the customer's base value, service value, potential value and referral value and may, for example, add up the different values using simple addition of the different values as the algorithm for determining the total value. The total value may also reflect other algorithms for combining the base value, service value, potential value and referral value to produce the total value, such as, for example, a weighted summation of the different values. In incorporating the base value, service value, potential value and referral value, the total value may reflect a mixed combination of actual, measurable values and projected, estimated, representative or otherwise proxy values.

FIG. 5 is a diagram illustrating calculation of a base value for consumer technology customers in accordance with an embodiment of the invention. The base value may incorporate the product or accessories profit value and the consumable profit value and may, for example, add up the different values using simple addition of the different values as the algorithm for determining the total base value. The base value may also reflect other algorithms for combining the product or accessories profit value and the consumable profit value to produce the total base value, such as, for example, a weighted summation of the different values.

The product or accessories profit value may reflect the basic profit to be earned from the sale to a customer of a consumer technology product or a related accessory to a consumer technology product. For example, the product profit value may reflect the profit gained from the sale of a personal computer, or the accessory profit value may reflect the profit gained from the sale of a printer as an accessory to a personal computer.

The consumable profit value may reflect the basic profit to be earned from the sale of consumable items related to a consumer technology product. For example, the consumable profit value may reflect the profit gained from the sale of such consumables as computer diskettes for storing information from a personal computer or ink cartridges related to a printer.

The profit earned from the sale of products, accessories or consumables may be calculated in different ways. The different determinations of profit may reflect different corporate objectives, accounting practices, marketing purposes, perceived customer values, internal algorithm requirements or other criteria. For example, the profit from the sale of products may be calculated taking into account only net revenues and variable costs directly related to the raw materials used in producing the product. Or, as another example, the profit may also incorporate allocations for labor input or for attributed overhead related to the manufacturing facility.

FIG. 6 is a diagram illustrating calculation of a service value for consumer technology customers in accordance with an embodiment of the invention. The service value may incorporate the subscription profit value, the service profit value and the support cost value and may, for example, sum up the different values using a simple summation of the different values as the algorithm for determining the total service value. The service value may also reflect other algorithms for combining the subscription profit value, the service profit value and the support cost value to produce the total service value, such as, for example, a weighted summation of the different values. In using a simple summation or a weighted summation, the total service value may effectively add the subscription profit value and the service profit value and subtract the support cost value to arrive at the total service value.

The subscription profit value may reflect the basic profit to be earned from the sale of subscriptions for additional services related to the consumer technology product. Such subscription services may include subscription for electronic services provided via the Internet, walk-in services provided at walk-in centers or retail outlets or telephone services provided at telecommunications call centers. Such subscription services may be sold during or after the sale of the underlying consumer technology product. For example, as part of a sale of a personal computer, a retail outlet may sell a subscription to the customer that allows the customer over the next twelve months to ask questions and receive other information over the Internet, and the subscription sold to the customer may have a determinable amount of profit used to calculate the subscription profit value.

The service profit value may reflect the basic profit to be earned from the sale of support services provided to the customer for consumer technology products. Such support services may include royalty and extended warranty services, may be sold during or after the sale of the underlying consumer technology product, and may be provided directly from the manufacturer, via a retailer or through third parties. For example, as part of a sale of a personal computer, a retail outlet may sell an extended warranty contract to the customer that extends the product warranty for another three years, and the extended warranty contract sold to the customer may have a determinable amount of profit used to calculate the service profit value.

The support cost may reflect the costs related to providing various basic support costs to the customer of consumer technology products. The basic support provided may be similar to the support provided through subscription or support services. For example, basic support provided at telecommunications call centers via telephones may also be used to provide support under extended warranty contracts. The support costs may or may not overlap with the costs related to providing subscription services and support services and may be calculated either as part of the subscription or service profit value or separately as support costs. In some cases, it may be difficult to distinguish whether the costs are part of basic support or subscription or support services. Basic support costs used in calculating the support cost value may reflect, for example, costs related to telecommunications call centers or basic warranty costs.

The profit earned from the sale of subscriptions and services may be calculated in different ways. The different determinations of profit may reflect different corporate objectives, accounting practices, marketing purposes, perceived customer values, internal algorithm requirements or other criteria. For example, the profit from selling a subscription or extended warranty may be calculated taking into account only net revenues and variable costs directly related to the sale, such as brochure or Website costs. Or, as another example, the profit may also incorporate costs associated with personnel conducting sales, such as salary, human resource benefit and commission costs. Or the profit may also incorporate some or all of the costs of delivering the subscription services or extended warranty services.

The cost used in calculating support cost values may be calculated in different ways. The different determinations of costs may reflect different corporate objectives, accounting practices, marketing purposes, perceived customer values, internal algorithm requirements or other criteria. For example, the cost for call centers or from the sale of products may be calculated taking into account only net revenues and variable costs directly related to the raw materials used in producing the product. Or, as another example, the profit may also incorporate allocations for labor input or for attributed overhead related to the manufacturing facility.

FIG. 7 is a diagram illustrating calculation of a potential value for consumer technology customers in accordance with an embodiment of the invention. The potential value may incorporate the cross-sell value and the re-sell value and may, for example, add up the different values using simple addition of the different values as the algorithm for determining the total potential value. The potential value may also reflect other algorithms for combining the cross-sell value and the re-sell value to produce the total potential value, such as, for example, a weighted summation of the different values.

The cross-sell value may reflect the basic profit in cross-selling related additional products and services to the consumer technology product customer. For example, the cross-sell value may include the value of various computer-related products like digital cameras sold to customers who already own a personal computer. The product profit used in the cross-sell value for these additional cross-sold products may reflect a profit proxy if the actual product profit is difficult to determine.

The re-sell value may reflect the basic profit in subsequently selling more products and services to the consumer technology product customer. For example, the re-sell value may include the value of selling a new personal computer to a customer whose existing personal computer is approaching the point in the product life cycle where the computer needs replacing. As another example, the re-sell value may include the value of warranty services or subscription services to be sold to the customer when the customer's existing warranty or subscription is about to expire.

The profit earned from the cross-selling or re-selling of products and services may be calculated in different ways. The different determinations of profit may reflect different corporate objectives, accounting practices, marketing purposes, perceived customer values, internal algorithm requirements or other criteria. For example, the profit from the sale of products may be calculated taking into account only net revenues and variable costs directly related to the raw materials used in producing the product. Or, as another example, the profit may also incorporate allocations for labor input or for attributed overhead related to the manufacturing facility.

FIG. 8 is a diagram illustrating calculation of a referral value for consumer technology customers in accordance with an embodiment of the invention. The referral value may reflect the value that influencers or “smart friends” provide to consumer technology companies when they act in a manner that effectively encourages new consumers to buy and use those products. These influencers are people that are identified as consumers whose opinion on products others seek out and respect. The referral value may reflect a proxy value, such as the imputed cost savings the consumer technology companies expect when the influencer wins the company new customers without the company needing to spend the additional marketing and advertising budget to target those new customers. For example, influencers who like a particular personal computer and refer their friends to buy them may be considered to have saved the computer company money the company would otherwise have needed to spend on creating and sending flyers to that particular group of potential customers.

FIG. 9 is a diagram illustrating the grouping of consumer technology customers in accordance with an embodiment of the invention. In determining a total value for customers, a consumer technology company may be able to compare the relative value and proportions of different customers and may benefit from breaking down the customers into value categories or groupings in order to determine more effectively how to take marketing actions with respect to each category or grouping. The grouping may reflect meaningful categories of values, the amount of customers in each grouping and the total sum of values of all customers in that grouping. Meaningful categories of values may not necessarily be value groupings of the same intervals of dollar amounts. For example, at higher values, it may be more useful to group customer values in $10 intervals instead of the $5 used at lower value groupings. From such groupings, a consumer technology company may, for example, look at the percentages of consumers in each grouping or the percentages of value contained in each group. For example, it may turn out for personal computers that the bulk of the customers may be in the groupings at the low end of the customer value groupings, which may help the personal computer company realize the extreme large benefit of targeting the few high value customers who also may be influencers.

FIG. 10 is a diagram illustrating categorizing groups of consumer technology customers in accordance with an embodiment of the invention. As described more fully in the discussion of FIG. 9 above, groupings of consumer technology customers may have substantial benefits for the consumer technology company. Creating value distribution curves displaying such groupings may provide further insight into the value of different groupings of customers and highlight more clearly the benefit of different groups of customers. Such curves may, for example, be generated automatically when values for customers have been determined. Programs may be created for each group of customers, similar to those, for example, created by airlines for frequent flyers and by automobile rental companies for frequent renters to distinguish high value customers from low value ones.

In the above description, numerous specific details are given to provide a thorough understanding of embodiments of the invention. However, the above description of illustrated embodiments of the invention is not intended to be exhaustive or to limit the invention to the precise forms disclosed. One skilled in the relevant art will recognize that the invention can be practiced without one or more of the specific details, or with other methods, components, etc. In other instances, well-known structures or operations are not shown or described in detail to avoid obscuring aspects of the invention. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. A system for multidimensional valuation of consumer technology customers, the system comprising:
a customer database interface for retrieving customer data relating to the consumer technology customers who purchased at least one product from a group of consumer technology products offered by a company;
an interface mechanism for retrieving multidimensional valuation terms; and
a valuation algorithm device for performing the multidimensional valuation of the consumer technology customers by applying the multidimensional valuation terms to the customer data.

2. The system of claim 1, wherein the multidimensional valuation terms comprises base valuation terms, service valuation terms, potential valuation terms, and referral valuation terms.

3. The system of claim 1, wherein the multidimensional valuation terms comprise base valuation terms.

4. The system of claim 3, wherein the base valuation terms comprise a product/accessory profit term and a consumable profit term.

5. The system of claim 1, wherein the multidimensional valuation terms comprise service valuation terms.

6. The system of claim 5, wherein the service valuation terms comprises a profit term and a cost term.

7. The system of claim 6, wherein the profit term comprises a subscription profit term and a service profit term.

8. The system of claim 7, wherein the cost term comprises a call center cost term and a warranty fulfillment cost term.

9. The system of claim 1, wherein the multidimensional valuation terms comprise potential valuation terms.

10. The system of claim 9, wherein the potential valuation terms include a re-sell value term and a cross-sell value term.

11. The system of claim 1, wherein the multidimensional valuation terms comprise referral valuation terms.

12. The system of claim 11, wherein the referral valuation terms include an influencer value term that relates to a savings in cost of consumer technology customer acquisition.

13. The system of claim 1, wherein bands of the consumer technology customers are categorized into value levels based on the multidimensional valuation.

14. The system of claim 13, wherein marketing communications to the customers differ depending on the value level of a customer.

15. The system of claim 14, wherein the marketing communications include promotional offers, and wherein customers with higher value levels receive promotional offers with larger discounts.

16. A method for multidimensional valuation of customers of consumer technology products, the method comprising:
retrieving customer data relating to customers who purchased at least one product from a group of consumer technology products offered by a company;
calculating a base value for the customers;
calculating a service value for the customers;
calculating a potential value for the customers; and
calculating a referral value for the customers; and
combining the base, service, potential, and referral values to determine the multidimensional valuation of the customers.

17. The method of claim 16, wherein the customers are categorized into value levels based on the multidimensional valuation.

18. The method of claim 17, wherein marketing communications to the customers differ depending on the value level of a customer.

19. The method of claim 18,
wherein the marketing communications include promotional offers, and
wherein customers with higher value levels receive promotional offers with larger discounts.
offers with larger discounts.

20. A system for multidimensional valuation of consumer technology customers, the system comprising:
means for retrieving customer data relating to customers who purchased at least one product from a group of consumer technology products offered by a company;
a base calculator for calculating a base value for the customers;
a service calculator for calculating a service value for the customers;
a potential calculator for calculating a potential value for the customers; and
a referral calculator for calculating a referral value for the customers; and
means for combining the base, service, potential, and referral values to determine the multidimensional valuation of the customers.

21. A system for multidimensional valuation of consumer technology customers, the system comprising: a customer database interface for retrieving customer data relating to the consumer technology customers who purchased at least one product from a group of consumer technology products offered by a company; an interface mechanism for retrieving multidimensional valuation terms; and a valuation algorithm device for performing the multidimensional valuation of the consumer technology customers by applying the multidimensional valuation terms to the customer data, wherein the multidimensional valuation terms comprises base valuation terms, service valuation terms, potential valuation terms, and referral valuation terms, wherein the base valuation terms comprise a product/accessory profit term and a consumable profit term, wherein the service valuation terms comprises a profit term and a cost term, wherein the potential valuation terms include a re-sell value term and a cross-sell value term, and wherein the referral valuation terms include an influencer value term that relates to a savings in cost of consumer technology customer acquisition.
